(19) United States
(12) Patent Application Publication
(10) Pub. No.: US 2022/0013780 A1
(43) Pub. Date: Jan. 13, 2022

(54) SECONDARY BATTERY AND ELECTROLYTE SOLUTION

(71) Applicant: Panasonic Intellectual Property Management Co., Ltd., Osaka-shi, Osaka (JP)

(72) Inventors: Satoshi Nishitani, Osaka (JP); Masaki Deguchi, Hyogo (JP)

(73) Assignee: Panasonic Intellectual Property Management Co., Ltd., Osaka-shi, Osaka (JP)

(21) Appl. No.: 17/295,513

(22) PCT Filed: Nov. 21, 2019
(86) PCT No.: PCT/JP2019/045703

§ 371 Date: May 20, 2021

(30) Foreign Application Priority Data
Nov. 30, 2018 (JP) 2018-225123

(51) Int. Cl. H01M 4/58; H01M 4/38; H01M 4/583; H01M 10/0562

(52) U.S. Cl. CPC H01M 4/5825; H01M 4/386; H01M 2004/027; H01M 10/0562; H01M 4/583

(57) ABSTRACT

A secondary battery includes a positive electrode, a negative electrode, and an electrolyte. The negative electrode includes a negative electrode active material capable of electrochemically absorbing and releasing lithium ions, and the negative electrode active material includes a first composite material containing a silicate phase and silicon particles dispersed in the silicate phase. The silicate phase includes at least one of an alkali metal and an alkaline earth metal. The content of the silicon particles in the first composite material is 30 mass % or more and 80 mass % or less. The electrolyte includes lithium fluorosulfonate.

### TECHNICAL FIELD

The present invention relates to a secondary battery and an electrolyte.

### BACKGROUND ART

In recent years, there has been a growing expectation for secondary batteries having a high voltage and a high energy density, such as non-aqueous electrolyte secondary batteries, as a promising power source for small consumer applications, power storage devices, and electric vehicles. With increasing demand for a higher battery energy density, a material containing silicon (Si) that forms an alloy with lithium has been expected to be utilized as a negative electrode active material having a high theoretical capacity density.

Patent Literature 1 discloses a non-aqueous electrolyte secondary battery including, as a negative electrode active material, a composite material containing a lithium silicate phase represented by Li_{2z}SiO_{2+z}, where 0<z<2, and silicon particles dispersed in the lithium silicate phase.

### CITATION LIST

### Patent Literature

[PTL 1] PCT Publication No. WO 2016/035290

### SUMMARY OF INVENTION

With development of portable electrical equipment with more sophisticated performance, for the secondary batteries expected as a promising power source for such equipment, further improvement in charge-discharge efficiency (higher capacity) has been required.

In view of the above, one aspect of the present invention relates to a secondary battery, including: a positive electrode; a negative electrode; and an electrolyte, wherein the negative electrode includes a negative electrode active material capable of electrochemically absorbing and releasing lithium ions, the negative electrode active material includes a first composite material containing a silicate phase and silicon particles dispersed in the silicate phase, the silicate phase includes at least one of an alkali metal and an alkaline earth metal, a content of the silicon particles in the first composite material is 30 mass % or more and 80 mass % or less, and the electrolyte includes lithium fluorosulfonate.

Another aspect of the present invention relates to an electrolyte for use in a secondary battery having a negative electrode including a first composite material containing a silicate phase and silicon particles dispersed in the silicate phase, the silicate phase including at least one of an alkali metal and an alkaline earth metal, the electrolyte including: lithium fluorosulfonate in an amount of 0.1 mass % or more and 2 mass % or less.

According to the present invention, the initial charge-discharge efficiency of the secondary battery can be improved.

### BRIEF DESCRIPTION OF DRAWING

FIG. 1 A partially cut-away schematic oblique view of a secondary battery according to one embodiment of the present invention.

### DESCRIPTION OF EMBODIMENTS

A secondary battery according to an embodiment of the present invention includes a positive electrode, a negative electrode, and an electrolyte. The negative electrode includes a negative electrode active material capable of electrochemically absorbing and releasing lithium ions, and the negative electrode active material includes a first composite material containing a silicate phase and silicon particles dispersed in the silicate phase. The silicate phase includes at least one (alkaline component) of an alkali metal and an alkaline earth metal. The content of the silicon particles in the first composite material is 30 mass % or more and 80 mass % or less. The electrolyte includes lithium fluorosulfonate (LiSO₃F).

Typically, in a battery including the first composite material, the initial charge-discharge efficiency decreases in some cases, as the utilization rate of the positive electrode active material decreases due to the irreversible capacity of the first composite material. The irreversible capacity of the first composite material is mainly attributed to the failure of some of the lithium ions having been absorbed into the silicate phase during charge to be released during discharge. To be specific, lithium ions are difficult to be released from Li₄SiO₄ having been locally produced in the silicate phase.

To address this, in the present invention, lithium fluorosulfonate is contained in the electrolyte. This can improve the initial charge-discharge efficiency of the battery including the first composite material. During the first charge, lithium ions derived from the lithium fluorosulfonate is efficiently supplied preferentially to the silicate phase. Although the detailed reason is unclear, it can be presumed as follows. As a result of the interaction between the lithium fluorosulfonate (fluorosulfonate component) and the silicate phase (alkaline component), the lithium fluorosulfonate tends to specifically come in contact with the silicate phase. The lithium ions that have been derived from the lithium fluorosulfonate and efficiently supplied preferentially to the silicate phase are efficiently utilized for the compensation of the irreversible capacity of the first composite material (the production of Li₄SiO₄). Thus, the lithium ions released from the positive electrode active material during the first charge are unlikely to be utilized for the production of Li₄SiO₄ in the silicate phase (directly or via the lithium ions in the electrolyte), and the decrease of the utilization rate of the positive electrode active material due to the irreversible capacity of the first composite material can be suppressed.

Moreover, for example, as a result that the lithium ions derived from the lithium fluorosulfonate are efficiently supplied preferentially to the silicate phase during the first charge, the crystallinity of the silicate phase is reduced, the lithium ion conductivity is improved, and the resistance becomes small. Therefore, the initial charge-discharge efficiency can be further improved.

By using the aforementioned electrolyte, thereby to improve the initial charge-discharge efficiency of the secondary battery having a negative electrode including the first composite material with high capacity, the initial capacity and the cycle characteristics (cycle capacity retention ratio) of the secondary battery can be improved.

The lithium fluorosulfonate may be present in the electrolyte as a fluorosulfonate anion. The fluorosulfonate anion may be present in the electrolyte in a form of fluorosulfonic acid combined with hydrogen. In the following, lithium fluorosulfonate, fluorosulfonic acid, and fluorosulfonate anion are sometimes collectively referred to as a fluorosulfonate group.

At least part of the lithium ions derived from the lithium fluorosulfonate contained in the electrolyte are utilized for the compensation of the irreversible capacity of the first composite material. Some of the lithium ions derived from the lithium fluorosulfonate may be utilized for securing the lithium ion conductivity of the electrolyte. In the case where the lithium ions derived from the lithium fluorosulfonate are mostly utilized for the compensation of the irreversible capacity of the first composite material, another lithium salt, such as LiPF₆, is preferably used in combination, in order to secure the lithium ion conductivity of the electrolyte. Also, in order to facilitate the dissociation of the lithium salt in the electrolyte, thereby to further enhance the lithium ion conductivity of the electrolyte, another lithium salt, such as LiPF₆, is preferably used in combination with the lithium fluorosulfonate.

The content (mass ratio to the whole electrolyte) of the lithium fluorosulfonate in the electrolyte at the time of preparing the electrolyte (before the first charge) is, for example, 0.1 mass % or more and 3 mass % or less, and is preferably 0.1 mass % or more and 2.5 mass % or less, more preferably 0.2 mass % or more and 2 mass % or less, further more preferably 0.5 mass % or more and 1.5 mass % or less.

When the content of the lithium fluorosulfonate is 0.1 mass % or more, the initial charge-discharge efficiency can be enhanced sufficiently. When the content of the lithium fluorosulfonate is 2 mass % or less, an appropriate amount of lithium ions for compensating the irreversible capacity of the negative electrode is efficiently supplied to the silicate phase. When the content of the lithium fluorosulfonate is 2 mass % or less, the lithium fluorosulfonate is likely to be dissociated in the electrolyte, and an electrolyte having moderate viscosity and excellent lithium ion conductivity is easily obtained. Thus, the supply of lithium ions to the silicate phase through the lithium fluorosulfonate can be more efficient.

When the content of the lithium fluorosulfonate at the time of preparing the electrolyte is 1 mass % or more, for example, in the battery after the first charge, the content (mass ratio to the whole electrolyte) of the lithium fluorosulfonate in the electrolyte is, for example, 15 ppm or less. The content of the lithium fluorosulfonate in the electrolyte taken out from the battery may be as small as close to the detection limit. When the presence of lithium fluorosulfonate in the electrolyte can be identified, the action and effect according thereto can be observed.

The content of the lithium fluorosulfonate in the electrolyte is determined as a sum of the amounts of the undissociated fluorosulfonic acid or lithium fluorosulfonate, and the fluorosulfonate anion, and can be determined by converting the whole amount into the mass of the lithium fluorosulfonate. In other words, it may be supposed that the fluorosulfonic group all comprises lithium fluorosulfonate, to determine the content. For example, when the electrolyte contains lithium fluorosulfonate, and the whole lithium fluorosulfonate is dissociated and present as an fluorosulfonate anion, the whole fluorosulfonate anion may be supposed to be lithium fluorosulfonate. The lithium fluorosulfonate amount contained in the electrolyte can be determined on the basis of the formula mass (105.99) of the lithium fluorosulfonate.

The content of the solvent in the electrolyte can be measured using, for example, gas chromatography mass spectrometry (GC-MS). The content of the lithium salt, such as the fluorosulfonate group, in the electrolyte can be measured using, for example, nuclear magnetic resonance (NMR) analysis, or ion chromatography.

The electrolyte preferably further contains at least one of LiN(SO₂F)₂ (hereinafter, LFSI) and LiPF₆, in terms of their wide potential window and high electric conductivity. LFSI can easily form a surface film (SEI: Solid Electrolyte Interface) with good quality on the LSX surface. LiPF₆ can form a passivation film moderately on the positive electrode current collector and others, and therefore, the corrosion of the positive electrode current collector and others can be suppressed, leading to an improved reliability of the battery.

The concentration of LFSI in the electrolyte is preferably 0.1 mol/L or more and 1.0 mol/L or less. The concentration of LiPF₆ in the electrolyte is preferably 0.5 mol/L or more and 1.5 mol/L or less. The total concentration of LFSI and LiPF₆ in the electrolyte is preferably 1 mol/L or more and 2 mol/L or less. In the case of using LFSI and LiPF₆ in combination in the above concentration range, the effects of LFSI and LiPF₆ as mentioned above can be produced in a balanced manner, and the initial charge-discharge efficiency of the battery can be further enhanced.

The negative electrode active material includes at least the first composite material with high capacity. By controlling the amount of silicon particles dispersed in the silicate phase, a further higher capacity can be achieved. Since silicon particles are dispersed in the silicate phase, the expansion and contraction of the first composite material during charge and discharge can be suppressed. The first composite material is therefore advantageous in achieving a higher capacity of the battery and improving the cycle characteristics.

The silicate phase contains at least one of an alkali metal (Group 1 element in the long-form periodic table) and an alkaline earth metal (Group 2 element in the long-form periodic table). The alkali metal includes, for example, lithium (Li), potassium (K), and sodium (Na). The alkaline earth metal includes, for example, magnesium (Mg), calcium (Ca), and barium (Ba). Particularly preferred is a lithium-containing silicate phase (hereinafter sometimes referred to as a lithium silicate phase) in terms of its small irreversible capacity, and a high initial charge-discharge efficiency. In other words, the first composite material is preferably a composite material (hereinafter sometimes referred to as LSX or a negative electrode material LSX) containing a lithium silicate phase and silicon particles dispersed in the lithium silicate phase.

For achieving a higher capacity and improving the cycle characteristics, the content of the silicon particles in the first composite material should be 30 mass % or more and 80 mass % or less.

When the content of the silicon particles in the first composite material is below 30 mass %, the proportion occupied by the silicate phase is high. In this case, the silicate phase cannot be fully supplied with the lithium ions derived from the lithium fluorosulfonate, and the improvement of the initial charge-discharge efficiency achieved by the addition of the lithium fluorosulfonate may be insufficient.

When the content of the silicon particles in the first composite material exceeds 80 mass %, the proportion occupied by the silicate phase is low. In this case, the lithium fluorosulfonate and the first composite material (silicate phase) can have less interaction with each other, and the improvement of the initial charge-discharge efficiency achieved by the addition of the lithium fluorosulfonate may be insufficient. Moreover, when the content of the silicon particles in the first composite material exceeds 80 mass %, the first composite material expands and contracts to a greater degree during charge and discharge, causing the cycle characteristics to degrade.

In view of achieving a higher capacity, the content of the silicon particles in the first composite material is preferably 35 mass % or more, more preferably 55 mass % or more. In this case, the lithium ions can diffuse favorably, making it easy to obtain excellent load characteristics. On the other hand, in view of improving the cycle characteristics, the content of the silicon particles in the first composite material is preferably 75 mass % or less, more preferably 70 mass % or less. In this case, the exposed surface area of the silicon particles without being covered with the silicate phase decreases, and the reaction between the electrolyte and the silicon particles tends to be suppressed.

The content of the silicon particles can be measured by Si-NMR. Desirable Si-NMR measurement conditions are shown below.

Measuring apparatus: Solid nuclear magnetic resonance spectrometer (NOVA-400), available from Varian, Inc.

Probe: Varian 7 mm CPMAS-2

MAS: 4.2 kHz

MAS speed: 4 kHz

Pulse: DD (45° pulse+signal capture time 1H decoupling)

Repetition time: 1200 sec

Observation width: 100 kHz

Observation center: around −100 ppm

Signal capture time: 0.05 sec

Number of times of accumulation: 560

Sample amount: 207.6 mg

The silicon particles dispersed in the lithium silicate phase have a particulate phase of silicon (Si) simple substance, and each composed of single crystallite or multiple crystallites. The silicon particles preferably has a crystallite size of 30 nm or less. When the crystallite size of the silicon particles is 30 nm or less, the change in volume of the silicon particles associated with expansion and contraction during charge and discharge can be reduced, and the cycle characteristics can be further improved. For example, the isolation of the silicon particle can be suppressed, which occurs in association with the contraction of the silicon particles, as voids are formed around the silicon particle and cause the contact points on the particle with the surrounding material to decrease. And the reduction in the charge-discharge efficiency due to the isolation of the particle can be suppressed. The lower limit of the crystallite size of the silicon particles is not specifically limited, but is, for example, 5 nm.

The crystallite size of the silicon particles is more preferably 10 nm or more and 30 nm or less, more preferably 15 nm or more and 25 nm or less. When the crystallite size of the silicon particles is 10 nm or more, the surface area of the silicon particles can be suppressed small, and the deterioration of the silicon particles accompanying the generation of irreversible capacity is unlikely to occur.

The crystallite size of the silicon particles can be calculated from the Scherrer formula, using a half-width of a diffraction peak attributed to the Si (111) plane of an X-ray diffractometry (XRD) pattern of the silicon particle.

The negative electrode active material may further include at least one of a second composite material and a third composite material. The second composite material contains a SiO₂ phase and silicon particles dispersed in the SiO₂ phase. The second composite material is represented by SiOₓ, where 0<x<2. The third composite material contains a carbon phase and silicon particles dispersed in the carbon phase. In view of suppressing the expansion and contraction of the third composite material during charge and discharge and achieving a higher capacity, the content of the silicon particles in the third composite material is preferably 20 mass % or more and 80 mass % or less. The negative electrode active material includes at least one of the second composite material and the third composite material in an amount of, for example, more than 0 parts by mass and 300 parts by mass or less, preferably 80 parts by mass or more and 190 parts by mass or less, relative to 100 parts by mass of the first composite material.

The second composite material is advantageous in that its expansion during charge is small. The third composite material has a large surface area and is advantageous against the charge and discharge at a large current. With the second composite material and the third composite material including the SiO₂ phase and the carbon material which are neutral, however, the interaction with the lithium fluorosulfonate as occurred in the case of the first composite material is unlikely to occur, and the preferential and effective supply of lithium ions is unlikely to be made.

In view of achieving a higher capacity and improving the cycle characteristics, the content (mass ratio to the whole negative electrode active material) of the first composite material in the negative electrode active material is preferably 1 mass % or more and 15 mass % or less. Likewise, the total content (mass ratio to the whole negative electrode active material) of the first composite material and at least one of the second composite material and the third composite material in the negative electrode active material is preferably 1 mass % or more and 15 mass % or less.

The first composite material, or a mixture of the first composite material and at least one of the second composite material and the third composite material (hereinafter, the first composite material etc.) expands and contracts during charge and discharge. When the content of the first composite material etc. in the negative electrode active material is 15 mass % or less, this can make the expansion and contraction of the first composite material etc. during charge and discharge have less influence on the contacting state between the negative electrode material mixture layer and the negative electrode current collector and between the negative electrode active material particles. By suppressing the content of the first composite material etc. in the negative electrode active material to 15 mass % or less and using one or more other negative electrode materials whose degree of expansion and contraction during charge and discharge is small as compared to that of the first composite material etc., it is possible to achieve excellent cycle characteristics, while imparting a high capacity of silicon particles to the negative electrode.

On the other hand, when the content of the first composite material etc. in the negative electrode active material is 1 mass % or more, a high capacity of the first composite material etc. (silicon particles) can be sufficiently imparted to the negative electrode.

The negative electrode active material preferably further includes a carbon material capable of electrochemically absorbing and releasing lithium ions, as another negative electrode material whose degree of expansion and contraction during charge and discharge is small as compared to that of the first composite material etc. The content (ratio to the total of the first composite material etc. and the carbon material) of the carbon material in the negative electrode active material is preferably 85 mass % or more and 99 mass % or less. This makes it easy to achieve a higher capacity, as well as to improve the cycle characteristics.

Examples of the carbon material include graphite, graphitizable carbon (soft carbon), and non-graphitizable carbon (hard carbon). Preferred among them is graphite, which is stable during charge and discharge and whose irreversible capacity is small. The graphite means a material having a graphite-like crystal structure, examples of which include natural graphite, artificial graphite, and graphitized mesophase carbon particles. These carbon materials may be used singly or in combination of two or more kinds.

A detailed description will be given below of the first composite material.

In view of suppressing the occurrence of cracks in the silicon particle itself, the average particle diameter of the silicon particles before the first charge is preferably 500 nm or less, more preferably 200 nm or less, further more preferably 50 nm or less. After the first charge, the average particle diameter of the silicon particles is preferably 400 nm or less, more preferably 100 nm or less. By refining the size of the silicon particles, the change in volume thereof during charge and discharge becomes small, which can further improve the structural stability of the first composite material.

The average particle diameter of the silicon particles is measured by observing a cross-sectional SEM (scanning electron microscope) photograph of the first composite material. Specifically, the average particle diameter of the silicon particles is obtained by averaging the maximum diameters of randomly selected 100 silicon particles. The silicon particle is an aggregate of a plurality of crystallites.

The silicate phase is, for example, a lithium silicate phase (oxide phase) containing lithium (Li), silicon (Si), and oxygen (O). The atomic ratio: O/Si of O to Si in the lithium silicate phase is, for example, more than two and less than four. When the O/Si is more than two and less than four (z in the below-mentioned formula satisfies 0<z<2), it becomes advantageous in the stability and the lithium ion conductivity. The O/Si is preferably more than two and less than three (z in the formula below satisfies 0<z<1). The atomic ratio: Li/Si of Li to Si in the lithium silicate phase is, for example, above zero and below four. The lithium silicate phase may contain, in addition to Li, Si, and O, a trace amount of other elements, such as iron (Fe), chromium (Cr), nickel (Ni), manganese (Mn), copper (Cu), molybdenum (Mo), zinc (Zn), and aluminum (Al).

The lithium silicate phase can have a composition represented by a formula: Li_{2z}SiO_{2+z}, where 0<z<2. In view of the stability, the ease of production, and the lithium ion conductivity, z preferably satisfies 0<z<1, and more preferably z=1/2.

In the lithium silicate phase of LSX, there are not so many sites that can react with lithium, as compared to in the SiO₂ phase of SiOₓ. Therefore, LSX is unlikely to produce an irreversible capacity associated with charge and discharge, as compared to SiOₓ. In the case of dispersing silicon particles in the lithium silicate, excellent charge-discharge efficiency can be obtained in the initial charge and discharge. Furthermore, the content of the silicon particles can be changed as desired, which makes it possible to design a high-capacity negative electrode.

The composition of the lithium silicate phase Li_{2z}SiO_{2+z} of the negative electrode material LSX can be analyzed, for example, by the following method.

First, the mass of a sample of the negative electrode material LSX is measured. Thereafter, the carbon, lithium, and oxygen contents in the sample are calculated as described below. Next, the carbon content is subtracted from the mass of the sample, to calculate the lithium and oxygen contents in the rest mass. The 2z and (2+z) ratios can be determined from the molar ratio of lithium (Li) to oxygen (O).

The carbon content can be measured using a carbon/sulfur analyzer (e.g., EMIA-520 available from HORIBA, Ltd.). A sample is weighed out on a magnetic board, to which an auxiliary agent is added. The sample is inserted into a combustion furnace (carrier gas: oxygen) heated to 1350° C. The amount of carbon dioxide gas generated during combustion is detected by infrared absorption spectroscopy. A calibration curve is obtained using carbon steel (carbon content: 0.49%) available from Bureau of Analysed Sampe. Ltd., from which a carbon content in the sample is determined (a high-frequency induction heating furnace combustion and infrared absorption method).

The oxygen content can be measured using an oxygen/nitrogen/hydrogen analyzer (e.g., EGMA-830, available from HORIBA, Ltd.). A sample is placed in a Ni capsule and put together with Sn pellets and Ni pellets serving as flux, into a carbon crucible heated at a power of 5.75 kW, to detect a produced carbon monoxide gas. From a calibration curve obtained using a standard sample Y₂O₃, an oxygen content in the sample is determined (an inert gas melting and non-dispersive infrared absorption method).

The lithium content can be measured as follows: a sample is completely dissolved in a heated fluoronitric acid (a heated mixed acid of hydrofluoric acid and nitric acid), followed by filtering to remove an undissolved residue, i.e., carbon, and then analyzing the obtained filtrate by inductively coupled plasma emission spectroscopy (ICP-AES). From a calibration curve obtained using a commercially available standard solution of lithium, a lithium content in the sample is determined.

Subtracting the carbon content, the oxygen content, and the lithium content from the mass of the sample of the negative electrode material LSX gives a silicon content. This silicon content involves a contribution of both silicon present in the form of silicon particles and that present in the form of lithium silicate. The content of the silicon particles can be determined by Si-NMR measurement, and this determines the content of the silicon present in the form of lithium silicate in the negative electrode material LSX.

The first composite material is preferably formed as a particulate material having an average particle diameter of 1 to 25 μm, and further, of 4 to 15 μm (hereinafter sometimes referred to as first particles). When the particle diameter is in the range as above, the stress caused by changes in volume of the first composite material associated with charge and discharge is likely to be reduced, and favorable cycle characteristics tend to be obtained. Also, the first particles tend to have a moderate surface area, and the reduction in capacity due to a side reaction with the electrolyte can be suppressed.

The average particle diameter of the first particles means a particle diameter at 50% cumulative volume (volume average particle diameter) in a volumetric particle diameter distribution measured by a laser diffraction and scattering method. For the measurement, for example, “LA-750”, available from Horiba, Ltd. (HORIBA) can be used.

The first particles preferably have an electrically conductive material covering at least part of its surface. The silicate phase is poor in electron conductivity. The electric conductivity of the first particles therefore tends to be low. By covering the surface with the conductive material, the conductivity can be improved significantly. The conductive layer is preferably thin enough not to substantially influence the average particle diameter of the first particles.

Next, a description will be given of a secondary battery according to an embodiment of the present invention. The secondary battery includes, for example, a negative electrode, a positive electrode, and an electrolyte as described below.

[Negative Electrode]

The negative electrode includes a negative electrode active material capable of electrochemically absorbing and releasing lithium ions. The negative electrode includes, for example, a negative electrode current collector, and a negative electrode material mixture layer formed on a surface of the negative electrode current collector and containing the negative electrode active material. The negative electrode material mixture layer can be formed by applying a negative electrode slurry formed of a negative electrode material mixture dispersed in a dispersion medium, onto a surface of the negative electrode current collector, followed by drying. The dry applied film may be rolled, if necessary. The negative electrode material mixture layer may be formed on one surface or both surfaces of the negative electrode current collector.

The negative electrode material mixture includes, as an essential component, a first composite material (first particles) serving as the negative electrode active material, and may include a binder, an electrically conductive agent, a thickener, and other optional components. The silicon particles in the negative electrode material LSX can absorb many lithium ions, and therefore, can contribute to increase the capacity of the negative electrode. The negative electrode material mixture may further include, as the negative electrode active material, at least one selected from the group consisting of a second composite material, a third composite material, and a carbon material that electrochemically absorbs and releases lithium ions.

Examples of the negative electrode current collector include a non-porous electrically conductive substrate (e.g., metal foil) and a porous electrically conductive substrate (e.g., mesh, net, punched sheet). The negative electrode current collector may be made of, for example, stainless steel, nickel, a nickel alloy, copper, or a copper alloy. The negative electrode current collector may have any thickness. In view of balancing between maintaining the strength and reducing the weight of the negative electrode, the thickness is preferably 1 to 50 μm, more preferably 5 to 20 μm.

The binder may be a resin material, examples of which include: fluorocarbon resin, such as polytetrafluoroethylene and polyvinylidene fluoride (PVDF); polyolefin resin, such as polyethylene and polypropylene; polyamide resin, such as aramid resin; polyimide resin, such as polyimide and polyamide-imide; acrylic resin, such as polyacrylic acid, polymethyl acrylate, and ethylene-acrylic acid copolymer; vinyl resin, such as polyacrylonitrile and polyvinyl acetate; polyvinylpyrrolidone; polyethersulfone; and a rubbery material, such as styrene-butadiene copolymer rubber (SBR). These may be used singly or in combination of two or more kinds.

Examples of the conductive agent include: carbons, such as acetylene black and carbon nanotubes; conductive fibers, such as carbon fibers and metal fibers; fluorinated carbon; metal powders, such as aluminum; conductive whiskers, such as zinc oxide and potassium titanate; conductive metal oxides, such as titanium oxide; and organic conductive materials, such as phenylene derivatives. These may be used singly or in combination of two or more kinds.

Examples of the thickener include: carboxymethyl cellulose (CMC) and modified products thereof (including salts, such as Na salt); cellulose derivatives (e.g., cellulose ethers), such as methyl cellulose; saponificated products of a polymer having a vinyl acetate unit, such as polyvinyl alcohol; and polyethers (e.g., polyalkylene oxide, such as polyethylene oxide). These may be used singly or in combination of two or more kinds.

The dispersion medium is not specifically limited and is exemplified by water, alcohols such as ethanol, ethers such as tetrahydrofuran, amides such as dimethylformamide, N-methyl-2-pyrrolidone (NMP), and a mixed solvent of these.

[Positive Electrode]

The positive electrode includes a positive electrode active material capable of electrochemically absorbing and releasing lithium ions. The positive electrode includes, for example, a positive electrode current collector, and a positive electrode material mixture layer formed on a surface of the positive electrode current collector. The positive electrode material mixture layer can be formed by applying a positive electrode slurry formed of a positive electrode material mixture dispersed in a dispersion medium, onto a surface of the positive electrode current collector, followed by drying. The dry applied film may be rolled, if necessary. The positive electrode material mixture layer may be formed on one surface or both surfaces of the positive electrode current collector. The positive electrode material mixture includes, as an essential component, the positive electrode active material, and may include a binder, an electrically conductive agent, and other optional components.

The positive electrode active material may be, for example, a lithium-containing composite oxide. Examples thereof include LiₐCoO₂, LiₐNiO₂, LiₐMnO₂, LiₐCo_{b}M_{1-b}O_{c}, LiₐNi_{1-b}M_{b}O_{c}, LiₐMn_{2-b}O₄, LiₐMn_{2-b}M_{b}O₄, LiMPO₄, and Li₂MPO₄F, where M is at least one selected from the group consisting of Na, Mg, Sc, Y, Mn, Fe, Co, Ni, Cu, Zn, Al, Cr, Pb, Sb, and B. Here, a=0 to 1.2, b=0 to 0.9, and c==2.0 to 23. The value “a” representing the molar ratio of lithium is subjected to increase and decrease during charge and discharge.

Preferred is a lithium-nickel composite oxide represented by LiₐNi_{b}M_{1-b}O₂, where M is at least one selected from the group consisting of Mn, Co, and Al, 0<a≤1.2, and 0.3≤b≤1. In view of achieving a higher capacity, b preferably satisfies 0.85≤b≤1. In view of the stability of the crystal structure, more preferred is LiₐNi_{b}Co_{c}Al_{d}O₂ containing Co and Al as elements represented by M, where 0<a≤1.2, 0.85≤b<1, 0<c<0.15, 0<d≤0.1, and b+c+d =1.

Examples of the binder and the conductive agent are as those exemplified for the negative electrode. Additional examples of the conductive agent include graphite, such as natural graphite and artificial graphite.

The form and the thickness of the positive electrode current collector may be respectively selected from the forms and the range corresponding to those of the negative electrode current collector. The positive electrode current collector may be made of, for example, stainless steel, aluminum, an aluminum alloy, and titanium.

[Electrolyte]

The electrolyte contains a solvent and an electrolytic material (solute). The solvent may be a non-aqueous solvent, and may be water. The electrolytic material includes at least a lithium salt. The electrolyte contains, for example, a non-aqueous solvent and a lithium salt dissolved in the non-aqueous solvent.

The concentration of the lithium salt in the electrolyte is preferably, for example, 0.5 mol/L or more and 2 mol/L or less. By controlling the concentration of the lithium salt in the range as above, an electrolyte having excellent ion conductivity and moderate viscosity can be obtained. The lithium salt concentration, however, is not limited to the above.

The non-aqueous solvent may be, for example, a cyclic carbonic acid ester (excluding the below-mentioned unsaturated cyclic carbonic ester), a chain carbonic acid ester, a cyclic carboxylic acid ester, or a chain carboxylic acid ester. Examples of the cyclic carbonic acid ester include propylene carbonate (PC) and ethylene carbonate (EC). Examples of the chain carbonic acid ester include diethyl carbonate (DEC), ethyl methyl carbonate (EMC), and dimethyl carbonate (DMC). Examples of the cyclic carboxylic acid ester include γ-butyrolactone (GBL) and γ-valerolactone (GVL). Examples of the chain carbonic acid ester include methyl formate, ethyl formate, propyl formate, methyl acetate, ethyl acetate, propyl acetate, methyl propionate, ethyl propionate, and propyl propionate. The non-aqueous solvent may be used singly or in combination of two or more kinds.

The lithium salt contains LiSO₃F as an essential component. The lithium salt may further contain one or more other lithium salts other than LiSO₃F. Examples of the other lithium salts include LiClO₄, LiBF₄, LiPF₆, LiAlCl₄, LiSbF₆, LiSCN, LiCF₃SO₃, LiCF₃CO₂, LiAsF₆, LiB₁₀Cl₁₀, lithium lower aliphatic carboxylate, LiCl, LiBr, LiI, borates, and imides. Examples of the borates include lithium bis(1,2-benzenediolate(2-)-O,O′) borate, lithium bis(2,3-naphthalenediolate(2-)-O,O′) borate, lithium bis(2,2′-biphenyldiolate(2-)-O,O′) borate, and lithium bis(5-fluoro-2-olate-1-benzenesulfonate-O,O′) borate. Examples of the imides include LFSI, lithium bistrifluoromethanesulfonyl imide (LiN(CF₃SO₂)₂), lithium trifluoromethanesulfonyl nonafluorobutanesulfonyl imide (LiN(CF₃SO₂)(C₄F₉SO₂)), and lithium bispentafluoroethanesulfonyl imide (LiN(C₂F₅SO₂)₂). Preferred among them is at least one of LiPF₆ and LFSI. These lithium salts may be used singly or in combination of two or more kinds.

The electrolyte may further contain an additive other than the above. Examples of the additive include succinic anhydride, maleic anhydride, ethylene sulfite, fluorobenzene, hexafluorobenzene, cyclohexylbenzene (CHB), 4-fluoroethylene carbonate (FEC), lithium bis(oxalato) borate (LiBOB), adiponitrile, and pimelonitrile. A cyclic carbonic ester having in its molecule at least one carbon-carbon unsaturated bond (hereinafter, an unsaturated cyclic carbonic ester) may be contained as an additive. The unsaturated cyclic carbonic acid ester, when decomposed on the negative electrode, forms a surface film with excellent lithium ion conductivity on the negative electrode. This can further enhance the charge-discharge efficiency.

The unsaturated cyclic carbonic acid ester may be a known compound. Preferred examples of the unsaturated cyclic carbonic acid ester include vinylene carbonate, 4-methylvinylene carbonate, 4,5-dimethylvinylene carbonate, 4-ethylvinylene carbonate, 4,5-diethylvinylene carbonate, 4-propylvinylene carbonate, 4,5-dipropylvinylene carbonate, 4-phenylvinylene carbonate, 4,5-diphenylvinylene carbonate, vinyl ethylene carbonate, and divinyl ethylene carbonate. Among them, at least one selected from the group consisting of vinylene carbonate, vinyl ethylene carbonate, and divinyl ethylene carbonate is preferred. These unsaturated cyclic carbonic acid esters may be used singly or in combination of two or more kinds. In the unsaturated cyclic carbonate ester, one or more hydrogen atoms may be substituted by fluorine atom.

[Separator]

Usually, it is desirable to interpose a separator between the positive electrode and the negative electrode. The separator is excellent in ion permeability and has moderate mechanical strength and electrically insulating properties. The separator may be, for example, a microporous thin film, a woven fabric, or a nonwoven fabric. The separator is preferably made of, for example, polyolefin, such as polypropylene or polyethylene.

In an exemplary structure of the secondary battery, an electrode group formed by winding the positive electrode and the negative electrode with the separator interposed therebetween is housed together with the electrolyte in an outer case. The wound-type electrode group may be replaced with a different form of the electrode group, for example, a stacked-type electrode group formed by stacking the positive electrode and the negative electrode with the separator interposed therebetween. The secondary battery may be in any form, such as cylindrical type, prismatic type, coin type, button type, or laminate type.

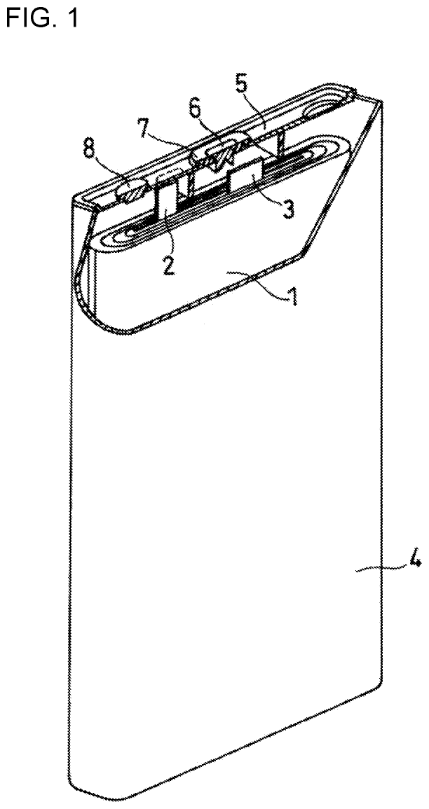

A description will be given below of the structure of a prismatic non-aqueous electrolyte secondary battery, as an example of a secondary battery according to the present invention, with reference to FIG. 1. FIG. 1 is a partially cut-away schematic oblique view of a secondary battery according to an embodiment of the present disclosure.

The battery includes a bottomed prismatic battery case 4, and an electrode group 1 and an electrolyte (not shown) housed in the battery case 4. The electrode group 1 has a long negative electrode, a long positive electrode, and a separator interposed therebetween and preventing the positive and negative electrodes from directly contacting with each other. The electrode group 1 is formed by winding the negative electrode, the positive electrode, and the separator around a flat plate-like winding core, and then removing the winding core.

A negative electrode lead 3 is attached at its one end to the negative electrode current collector of the negative electrode, by means of welding or the like. The negative electrode lead 3 is electrically connected at its other end, via an electrically insulating plate (not shown) made of resin, to a negative electrode terminal 6 disposed at a sealing plate 5. The negative electrode terminal 6 is electrically insulated from the sealing plate 5 by the resin gasket 7. A positive electrode lead 2 is attached at its one end to the positive electrode current collector of the positive electrode, by means of welding or the like. The positive electrode lead 2 is electrically connected at its other end, via the insulating plate, to the back side of the sealing plate 5. In other words, the positive electrode lead 2 is electrically connected to the battery case 4 serving as a positive electrode terminal. The insulating plate separates the electrode group 1 from the sealing plate 5, and separates the negative electrode lead 3 from the battery case 4. The sealing plate 5 is fitted at its periphery to the opening end of the battery case 4, and the fitted portion is laser-welded. In this way, the opening of the battery case 4 is sealed with the sealing plate 5. The electrolyte injection hole provided in the sealing plate 5 is closed with a sealing stopper 8.

The present disclosure will be specifically described below with reference to Examples and Comparative Examples. It is to be noted, however, the present invention is not limited to the following Examples.

### EXAMPLE 1

[Preparation of First Composite Material (Negative Electrode Material LSX)]

Silicon dioxide and lithium carbonate were mixed so as to contain Si and Li in an atomic ratio: Si/Li of 1.05. The mixture was heated in the air at 950° C. for 10 hours, to obtain a lithium silicate represented by Li₂Si₂O₅ (z=0.5). The obtained lithium silicate was pulverized to have an average particle diameter of 10 μm.

The lithium silicate (Li₂Si₂O₅) having an average particle diameter of 10 μm was mixed with a raw material silicon (3N, average particle diameter: 10 μm) in a mass ratio of 70:30. The mixture was placed in a pot (made of SUS, volume: 500 mL) of a planetary ball mill (P-5, available from Fritsch Co., Ltd.), together with 24 SUS balls (diameter: 20 mm). In the pot with the lid closed, the mixture was pulverized at 200 rpm for 50 hours in an inert atmosphere.

Next, the powdered mixture was taken out from the pot in an inert atmosphere, which was then heated at 800° C. for 4 hours, in an inert atmosphere, with a predetermined pressure applied by a hot press, to give a sintered body of the mixture (a negative electrode material LSX).

Thereafter, the negative electrode material LSX was pulverized and passed through a 40-μm mesh. The resultant LSX particles were mixed with a coal pitch (MCP 250, available from JFE Chemical Corporation). The mixture was then heated at 800° C. in an inert atmosphere, to coat the LSX particles with an electrically conductive carbon, so that a conductive layer was formed on the particle surface. The coating amount of the conductive layer was set to 5 mass %, relative to the total mass of the LSX particles and the conductive layer. Thereafter, with a sieve, LSX particles being 5 μm in average diameter and having the conductive layer were obtained.

The crystallite size of the silicon particles calculated using the Scherrer formula from a diffraction peak attributed to the Si (111) plane obtained by XRD analysis of the LSX particles was 15 nm.

The composition of the lithium silicate phase was analyzed using the above-mentioned methods (high-frequency induction heating furnace combustion and infrared absorption method, inert gas melting and non-dispersion type infrared absorption method, inductively coupled plasma emission spectroscopy (ICP-AES)). The result showed that the Si/Li ratio was 1.0, and the content of Li₂Si₂O₅ measured by Si-NMR was 70 mass % (the content of the silicon particles was 30 mass %).

[Production of Negative Electrode]

The LSX particles having the conductive layer were mixed with graphite in a mass ratio of 5:95, and the resultant mixture was used as a negative electrode active material. The negative electrode active material was mixed with a sodium salt of carboxymethyl cellulose (CMC-Na) and styrene-butadiene rubber (SBR) in a mass ratio of 97.5:1:1.5, to which water was added. The mixture was stirred in a mixer (T.K. HMS MIX, available from PRIMIX Corporation), to prepare a negative electrode slurry.

Next, the negative electrode slurry was applied onto copper foil, so that the mass of a negative electrode material mixture per 1 m² of the copper foil was 190 g. The applied film was dried, and then rolled, to give a negative electrode with a negative electrode material mixture layer having a density of 1.5 g/cm³ formed on both sides of the copper foil.

[Production of Positive Electrode]

A lithium-nickel composite oxide (LiNi_{0.8}Co_{0.18}Al_{0.02}O₂) was mixed with acetylene black and polyvinylidene fluoride in a mass ratio of 95:2.5:2.5, to which N-methyl-2-pyrrolidone (NMP) was added. The mixture was stirred in a mixer (T.K. HMS MIX, available from PRIMIX Corporation), to prepare a positive electrode slurry. Next, the positive electrode slurry was applied onto aluminum foil. The applied film was dried, and then rolled, to give a positive electrode with a positive electrode mixture layer having a density of 3.6 g/cm³ formed on both sides of the aluminum foil.

[Preparation of Electrolyte]

A lithium salt was dissolved in a non-aqueous solvent, to prepare an electrolyte. The non-aqueous solvent used here was a mixed solvent containing ethylene carbonate (EC), dimethyl carbonate (DMC), and methyl acetate (MA) in a volume ratio of 20:40:40. The lithium salt used here was LiSO₃F and LiPF₆. The content of LiSO₃F in the electrolyte was set to 0.5 mass %. The concentration of LiPF₆ in the electrolyte was set to 1.1 mol/L.

[Fabrication of Non-Aqueous Electrolyte Secondary Battery]

The positive electrode and the negative electrode, with a tab attached to each electrode, were wound spirally with a separator interposed therebetween such that the tab was positioned at the outermost layer, thereby to form an electrode group. The electrode group was inserted into an outer case made of aluminum laminated film and dried under vacuum at 105° C. for 2 hours. The electrolyte was injected into the case, and the opening of the outer case was sealed. A battery Al was thus obtained.

### EXAMPLE 2

In the preparation of a negative electrode material LSX, lithium silicate (Li₂Si₂O₅) of 10 μm in average particle diameter and a raw material silicon (3N, average particle diameter: 10 μm) were mixed in a mass ratio of 50:50. With respect to the obtained LSX particles having the conductive layer, the content of Li₂Si₂O₅ was measured by Si-NMR, which was 50 mass % (the content of the silicon particles was 50 mass %).

In the production of a negative electrode, the LSX particles having the conductive layer were mixed with the graphite in a mass ratio of 3:97, and the resultant mixture was used as a negative electrode active material.

In the preparation of an electrolyte, LiSO₃F, LiPF₆, and LFSI were used as the lithium salt. The content of LiSO₃F in the electrolyte was set to 1.0 mass %. The concentration of LiPF₆ in the electrolyte was set to 1.1 mol/L. The concentration of LFSI in the electrolyte was set to 0.1 mol/L.

A battery A2 was fabricated in the same manner as in Example 1, except the above.

### EXAMPLE 3

In the preparation of a negative electrode material LSX, lithium silicate (Li₂Si₂O₅) of 10 μm in average particle diameter and a raw material silicon (3N, average particle diameter: 10 μm) were mixed in a mass ratio of 40:60. With respect to the obtained LSX particles having the conductive layer, the content of Li₂Si₂O₅ was measured by Si-NMR, which was 40 mass % (the content of the silicon particles was 60 mass %).

In the production of a negative electrode, the LSX particles having the conductive layer were mixed with the graphite in a mass ratio of 2.5:97.5, and the resultant mixture was used as a negative electrode active material.

In the preparation of an electrolyte, LiSO₃F and LiPF₆ were used in combination as the lithium salt. The content of LiSO₃F in the electrolyte was set to 2.0 mass %. The concentration of LiPF₆ in the electrolyte was set to 1.2 mol/L.

A battery A3 was fabricated in the same manner as in Example 1, except the above.

### EXAMPLE 4

In the preparation of a negative electrode material LSX, lithium silicate (Li₂Si₂O₅) of 10 μm in average particle diameter and a raw material silicon (3N, average particle diameter: 10 μm) were mixed in a mass ratio of 55:45. With respect to the obtained LSX particles having the conductive layer, the content of Li₂Si₂O₅ was measured by Si-NMR, which was 55 mass % (the content of the silicon particles was 45 mass %).

In the production of a negative electrode, the LSX particles having the conductive layer were mixed with a third composite material (SiC particles) and the graphite in a mass ratio of 1.7:2.5:95.8, and the resultant mixture was used as a negative electrode active material. The content of the silicon particles in the third composite material was set to 30 mass %, and the average particle diameter of the third composite material was set to 5 μm.

In the preparation of an electrolyte, LiSO₃F, LiPF₆, and LFSI were used as the lithium salt. The content of LiSO₃F in the electrolyte was set to 1.5 mass %. The concentration of LiPF₆ in the electrolyte was set to 0.9 mol/L. The concentration of LFSI in the electrolyte was set to 0.2 mol/L.

A battery A4 was fabricated in the same manner as in Example 1, except the above.

### EXAMPLE 5

In the preparation of an electrolyte, LiSO₃F and LiPF₆ were used in combination as the lithium salt. The content of LiSO₃F in the electrolyte was set to 1.0 mass %. The concentration of LiPF₆ in the electrolyte was set to 1.0 mol/L.

A battery A5 was fabricated in the same manner as in Example 1, except the above.

### EXAMPLE 6

In the preparation of a negative electrode material LSX, lithium silicate (Li₂Si₂O₅) of 10 μm in average particle diameter and a raw material silicon (3N, average particle diameter: 10 μm) were mixed in a mass ratio of 25:75. With respect to the obtained LSX particles having the conductive layer, the content of Li₂Si₂O₅ was measured by Si-NMR, which was 25 mass % (the content of the silicon particles was 75 mass %).

In the production of a negative electrode, the LSX particles having the conductive layer were mixed with the graphite in a mass ratio of 2:98, and the resultant mixture was used as a negative electrode active material.

In the preparation of an electrolyte, LiSO₃F and LiPF₆ were used in combination as the lithium salt. The content of LiSO₃F in the electrolyte was set to 1.0 mass %. The concentration of LiPF₆ in the electrolyte was set to 1.1 mol/L.

A battery A6 was fabricated in the same manner as in Example 1, except the above.

### EXAMPLE 7

In the preparation of a negative electrode material LSX, lithium silicate (Li₂Si₂O₅) of 10 μm in average particle diameter and a raw material silicon (3N, average particle diameter: 10 μm) were mixed in a mass ratio of 45:55. With respect to the obtained LSX particles having the conductive layer, the content of Li₂Si₂O₅ was measured by Si-NMR, which was 45 mass % (the content of the silicon particles was 55 mass %).

In the production of a negative electrode, the LSX particles having the conductive layer were mixed with a second composite material and the graphite in a mass ratio of 1:2.9:96.1, and the resultant mixture was used as a negative electrode active material. The second composite material used was SiO particles (x=1, average particle diameter: 5 μm).

In the preparation of an electrolyte, LiSO₃F, LiPF₆, and LFSI were used as the lithium salt. The content of LiSO₃F in the electrolyte was set to 1.0 mass %. The concentration of LiPF₆ in the electrolyte was set to 0.4 mol/L. The concentration of LFSI in the electrolyte was set to 0.7 mol/L.

A battery A7 was fabricated in the same manner as in Example 1, except the above.

### EXAMPLE 8

In the preparation of a negative electrode material LSX, lithium silicate (Li₂Si₂O₅) of 10 μm in average particle diameter and a raw material silicon (3N, average particle diameter: 10 μm) were mixed in a mass ratio of 50:50. With respect to the obtained LSX particles having the conductive layer, the content of Li₂Si₂O₅ was measured by Si-NMR, which was 50 mass % (the content of the silicon particles was 50 mass %).

In the production of a negative electrode, the LSX particles having the conductive layer were mixed with the graphite in a mass ratio of 3:97, and the resultant mixture was used as a negative electrode active material.

In the preparation of an electrolyte, LiSO₃F and LFSI were used as the lithium salt. The content of LiSO₃F in the electrolyte was set to 0.05 mass %. The concentration of LiPF₆ in the electrolyte was set to 1.0 mol/L.

A battery A8 was fabricated in the same manner as in Example 1, except the above.

### EXAMPLE 9

In the preparation of a negative electrode material LSX, lithium silicate (Li₂Si₂O₅) of 10 μm in average particle diameter and a raw material silicon (3N, average particle diameter: 10 μm) were mixed in a mass ratio of 50:50. With respect to the obtained LSX particles having the conductive layer, the content of Li₂Si₂O₅ was measured by Si-NMR, which was 50 mass % (the content of the silicon particles was 50 mass %).

In the production of a negative electrode, the LSX particles having the conductive layer were mixed with the graphite in a mass ratio of 3:97, and the resultant mixture was used as a negative electrode active material.

In the preparation of an electrolyte, LiSO₃F and LiPF₆ were used as the lithium salt. The content of LiSO₃F in the electrolyte was set to 0.1 mass %. The concentration of LiPF₆ in the electrolyte was set to 1.0 mol/L.

A battery A9 was fabricated in the same manner as in Example 1, except the above.

### COMPARATIVE EXAMPLE 1

In the preparation of a negative electrode material LSX, lithium silicate (Li₂Si₂O₅) of 10 μm in average particle diameter and a raw material silicon (3N, average particle diameter: 10 μm) were mixed in a mass ratio of 50:50. With respect to the obtained LSX particles having the conductive layer, the content of Li₂Si₂O₅ was measured by Si-NMR, which was 50 mass % (the content of the silicon particles was 50 mass %).

In the production of a negative electrode, the LSX particles having the conductive layer were mixed with the graphite in a mass ratio of 3:97, and the resultant mixture was used as a negative electrode active material.

In the preparation of an electrolyte, LiSO₃F was not used, and LiPF₆ was used as the lithium salt. The concentration of LiPF₆ in the electrolyte was set to 1.1 mol/L.

A battery B1 was fabricated in the same manner as in Example 1, except the above.

### COMPARATIVE EXAMPLE 2

In the preparation of a negative electrode material LSX, lithium silicate (Li₂Si₂O₅) of 10 μm in average particle diameter and a raw material silicon (3N, average particle diameter: 10 μm) were mixed in a mass ratio of 75:25. With respect to the obtained LSX particles having the conductive layer, the content of Li₂Si₂O₅ was measured by Si-NMR, which was 75 mass % (the content of the silicon particles was 25 mass %).

In the production of a negative electrode, the LSX particles having the conductive layer were mixed with the graphite in a mass ratio of 6:94, and the resultant mixture was used as a negative electrode active material.

In the preparation of an electrolyte, LiSO₃F and LiPF₆ were used as the lithium salt. The content of LiSO₃F in the electrolyte was set to 2.5 mass %. The concentration of LiPF₆ in the electrolyte was set to 1.2 mol/L.

A battery B2 was fabricated in the same manner as in Example 1, except the above.

### COMPARATIVE EXAMPLE 3

In the production of a negative electrode, without using the LSX particles having the conductive layer as the negative electrode active material, SiO and the graphite were mixed in a mass ratio of 5:95, and the resultant mixture was used as the negative electrode active material.

In the preparation of an electrolyte, LiSO₃F was not used, and LiPF₆ was used as the lithium salt. The concentration of LiPF₆ in the electrolyte was set to 1.1 mol/L.

A battery B3 was fabricated in the same manner as in Example 1, except the above.

### COMPARATIVE EXAMPLE 4

In the preparation of a negative electrode material LSX, lithium silicate (Li₂Si₂O₅) of 10 μm in average particle diameter and a raw material silicon (3N, average particle diameter: 10 μm) were mixed in a mass ratio of 15:85. With respect to the obtained LSX particles having the conductive layer, the content of Li₂Si₂O₅ was measured by Si-NMR, which was 15 mass % (the content of the silicon particles was 85 mass %).

In the production of a negative electrode, the LSX particles having the conductive layer were mixed with the graphite in a mass ratio of 2:98, and the resultant mixture was used as a negative electrode active material.

In the preparation of an electrolyte, LiSO₃F and LiPF₆ were used as the lithium salt. The content of LiSO₃F in the electrolyte was set to 0.5 mass %. The concentration of LiPF₆ in the electrolyte was set to 1.2 mol/L.

A battery B4 was fabricated in the same manner as in Example 1, except the above.

### COMPARATIVE EXAMPLE 5

In the preparation of a negative electrode material LSX, lithium silicate (Li₂Si₂O₅) of 10 μm in average particle diameter and a raw material silicon (3N, average particle diameter: 10 μm) were mixed in a mass ratio of 55:45. With respect to the obtained LSX particles having the conductive layer, the content of Li₂Si₂O₅ was measured by Si-NMR, which was 55 mass % (the content of the silicon particles was 45 mass %).

In the production of a negative electrode, the LSX particles having the conductive layer were mixed with the graphite in a mass ratio of 3.5:96.5, and the resultant mixture was used as a negative electrode active material.

In the preparation of an electrolyte, LiSO₃F was not used, and LiPF₆ and LFSI were used as the lithium salt. The concentration of LiPF₆ in the electrolyte was set to 0.4 mol/L. The concentration of LFSI in the electrolyte was set to 0.7 mol/L.

A battery B5 was fabricated in the same manner as in Example 1, except the above.

### COMPARATIVE EXAMPLE 6

In the preparation of a negative electrode material LSX, lithium silicate (Li₂Si₂O₅) of 10 μm in average particle diameter and a raw material silicon (3N, average particle diameter: 10 μm) were mixed in a mass ratio of 55:45. With respect to the obtained LSX particles having the conductive layer, the content of Li₂Si₂O₅ was measured by Si-NMR, which was 55 mass % (the content of the silicon particles was 45 mass %).

In the production of a negative electrode, the LSX particles having the conductive layer were mixed with the graphite in a mass ratio of 3.5:96.5, and the resultant mixture was used as a negative electrode active material.

In the preparation of an electrolyte, LiSO₃F was not used, and LFSI was used as the lithium salt. The concentration of LFSI in the electrolyte was set to 1.0 mol/L.

A battery B6 was fabricated in the same manner as in Example 1, except the above.

### COMPARATIVE EXAMPLE 7

In the production of a negative electrode, without using the LSX particles having the conductive layer as the negative electrode active material, SiO particles (x=1, average particle diameter: 5 μm) and the graphite were mixed in a mass ratio of 5:95, and the resultant mixture was used as a negative electrode active material.

In the preparation of an electrolyte, LiSO₃F and LiPF₆ were used as the lithium salt. The content of LiSO₃F in the electrolyte was set to 1.0 mass %. The concentration of LiPF₆ in the electrolyte was set to 1.0 mol/L.

A battery B7 was fabricated in the same manner as in Example 1, except the above.

### COMPARATIVE EXAMPLE 8

A battery B8 was fabricated in the same manner as in Comparative Example 7, except that SiC particles (silicon particle content: 30 mass %, average particle diameter: 5 μm) were used in place of the SiO particles.

Each of the batteries fabricated above was evaluated by the following method.

[Evaluation 1: Initial Capacity]

With respect to the fabricated batteries, a constant-current charge was performed at a current of 0.3 It until the voltage reached 4.2 V, and then a constant-voltage charge was performed at a voltage of 4.2 V until the current reached 0.015 It. This was followed by a constant-current discharge at 0.3 It until the voltage reached 2.75 V. The rest time between charge and discharge was set to 10 minutes. The charge and discharge were performed in a 25° C. environment. A discharge capacity at this time was measured as an initial capacity. The results are shown in Table 1.

Here, (1/x)It represents a current, and (1/x)It (A)=Rated capacity (Ah)/X(h), where X represents the time consumed for charging or discharging electricity equivalent to the rated capacity. For example, 0.5 It represents a case where X=2 and means that the current value is the rated capacity (Ah)/2(h).

[Evaluation 2: Cycle Capacity Retention Ratio]

A constant-current charge was performed at a current of 0.3 It until the voltage reached 4.2 V, and then, a constant-voltage charge was performed at a voltage of 4.2 V until the current reached 0.015 It. This was followed by a constant-current discharge at 0.3 It until the voltage reached 2.75 V. The rest time between charge and discharge was set to 10 minutes. The charge and discharge were performed in a 25° C. environment.

Charge and discharge was repeated under the charge and discharge conditions above. The ratio (percentage) of a discharge capacity at the 300th cycle to a discharge capacity at the 1st cycle was calculated as a cycle capacity retention ratio.

The evaluation results are shown in Table 1.

TABLE 1

| | | Negative electrode active material | | | | | | | | Evaluation | |
|---|---|---|---|---|---|---|---|---|---|---|---|
| | | | Si | | | | | | | | Cycle |
| | | | particle | | | | Electrolyte | | | | capacity |
| | | LSX | content | SiO | SiC | Graphite | LiPF₆ | LFSI | LiSO₃F | Initial | retention |
| | Battery | content | in LSX | content | content | content | concentration | concentration | content | capacity | ratio |
| | No. | (mass %) | (mass %) | (mass %) | (mass %) | (mass %) | (mol/L) | (mol/L) | (mass %) | (mAh) | (%) |
| Ex. 1 | A1 | 5.0 | 30 | 0 | 0 | 95.0 | 1.1 | 0 | 05 | 1136 | 95 |
| Ex. 2 | A2 | 3.0 | 50 | 0 | 0 | 97.0 | 1.1 | 0.1 | 1.0 | 1130 | 94 |
| Ex. 3 | A3 | 25 | 60 | 0 | 0 | 97.5 | 12 | 0 | 2.0 | 1128 | 94 |
| Ex. 4 | A4 | 1.7 | 45 | 0 | 25 | 95.8 | 0.9 | 02 | 15 | 1129 | 93 |
| Ex. 5 | A5 | 5.0 | 30 | 0 | 0 | 95.0 | 1.0 | 0 | 1.0 | 1136 | 95 |
| Ex. 6 | A6 | 2.0 | 75 | 0 | 0 | 98.0 | 1.1 | 0 | 1.0 | 1140 | 94 |
| Ex. 7 | A7 | 1.0 | 55 | 2.9 | 0 | 96.1 | 0.4 | 0.7 | 1.0 | 1143 | 94 |
| Ex. 8 | A8 | 3.0 | 50 | 0 | 0 | 97.0 | 1.0 | 0 | 0.05 | 1121 | 93 |
| Ex. 9 | A9 | 3.0 | 50 | 0 | 0 | 97.0 | 1.0 | 0 | 0.1 | 1125 | 93 |
| Com. Ex. 1 | B1 | 3.0 | 50 | 0 | 0 | 97.0 | 1.1 | 0 | 0 | 1107 | 84 |
| Com. Ex. 2 | B2 | 6.0 | 25 | 0 | 0 | 94.0 | 12 | 0 | 2.5 | 1105 | 73 |
| Com. Ex. 3 | B3 | 0 | — | 5.0 | 0 | 95.0 | 1.1 | 0 | 0 | 1083 | 66 |
| Com. Ex. 4 | B4 | 2.0 | 85 | 0 | 0 | 98.0 | 12 | 0 | 0.5 | 1021 | 62 |
| Com. Ex. 5 | B5 | 35 | 45 | 0 | 0 | 96.5 | 0.4 | 0.7 | 0 | 1078 | 80 |
| Com. Ex. 6 | B6 | 3.5 | 45 | 0 | 0 | 96.5 | 0 | 1.0 | 0 | 1082 | 80 |
| Com. Ex. 7 | B7 | 0 | — | 5.0 | 0 | 95.0 | 1.0 | 0 | 1.0 | 1063 | 78 |
| Com. Ex. 8 | B8 | 0 | — | 0 | 5.0 | 95.0 | 1.0 | 0 | 1.0 | 1071 | 74 |

The batteries A1 to A3, A5, A6, A8 and A9 including an electrolyte containing LiSO₃F and a negative electrode containing LSX particles exhibited a high initial capacity and a high cycle capacity retention ratio. In the batteries A1 to A3, A5 to A7, and A9 including an electrolyte having a LiSO₃F content of 0.1 to 2 mass %, the initial charge-discharge efficiency (initial capacity) was further improved. In the batteries A4 and A7, too, including a negative electrode containing LSX particles in combination with SiO particles or SiC particles, a high initial capacity and a high cycle capacity retention ratio were obtained.

In the batteries B1, B5 and B6 in which the electrolyte contained no LiSO₃F, the initial capacity and the cycle capacity retention ratio were degraded. In the battery B2, in which the Si particle content in the LSX particles was less than 30 mass %, the initial capacity was degraded. In the battery B3, in which SiO particles and graphite were used as the negative electrode active material, and the electrolyte contained no LiSO₃F, the initial capacity and the cycle capacity retention ratio were degraded. In the battery B4, in which the Si particle content in the LSX particles exceeded 80 mass %, the initial capacity and the cycle capacity retention ratio were degraded. In the battery B7, in which the electrolyte contained LiSO₃F, but SiO particles and graphite were used as the negative electrode active material, the initial capacity and the cycle capacity retention ratio were degraded. In the battery B8, in which the electrolyte contained LiSO₃F, but SiC particles and graphite were used as the negative electrode active material, the initial capacity and the cycle capacity retention ratio were degraded.

### INDUSTRIAL APPLICABILITY

The secondary battery according to the present invention is useful as a main power source for mobile communication equipment, portable electronic equipment, and other devices.

### REFERENCE SIGNS LIST

1: electrode group

2: positive electrode lead

3: negative electrode lead

4: battery case

5: sealing plate

6: negative electrode terminal

7: gasket

8: sealing stopper

1. A secondary battery, comprising:
a positive electrode; a negative electrode; and an electrolyte, wherein
the negative electrode includes a negative electrode active material capable of electrochemically absorbing and releasing lithium ions,
the negative electrode active material includes a first composite material containing a silicate phase and silicon particles dispersed in the silicate phase,
the silicate phase includes at least one of an alkali metal and an alkaline earth metal,
a content of the silicon particles in the first composite material is 30 mass % or more and 80 mass % or less, and
the electrolyte includes lithium fluorosulfonate.

2. The secondary battery according to claim 1, wherein a content of the lithium fluorosulfonate in the electrolyte is 0.1 mass % or more and 2 mass % or less.

3. The secondary battery according to claim 1 or 2, wherein the electrolyte further includes at least one of LiN(SO₂F)₂ and LiPF₆.

4. The secondary battery according to claim 3, wherein a concentration of the LiN(SO₂F)₂ in the electrolyte is 0.1 mol/L or more and 1.0 mol/L or less.

5. The secondary battery according to claim 3 or 4, wherein a concentration of the LiPF₆ in the electrolyte is 0.5 mol/L or more and 1.5 mol/L or less.

6. The secondary battery according to any one of claims 1 to 5, wherein
the silicate phase has a composition represented by a formula: Li₄SiO_{2+z}, and
z in the formula satisfies 0<z<1.

7. The secondary battery according to any one of claims 1 to 6, wherein the silicon particle has a crystallite sizes of 30 nm or less.

8. The secondary battery according to any one of claims 1 to 7, wherein
the negative electrode active material further includes at least one of a second composite material and a third composite material,
the second composite material containing a SiO₂ phase and silicon particles dispersed in the SiO₂ phase,
the third composite material containing a carbon phase and silicon particles dispersed in the carbon phase.

9. The secondary battery according to claim 8, wherein a total content of the first composite material and at least one of the second composite material and the third composite material in the negative electrode active material is 1 mass % or more and 15 mass % or less.

10. An electrolyte for use in a secondary battery having a negative electrode including a first composite material containing a silicate phase and silicon particles dispersed in the silicate phase, the silicate phase including at least one of an alkali metal and an alkaline earth metal, the electrolyte including:
lithium fluorosulfonate in an amount of 0.1 mass % or more and 2 mass % or less.

11. The electrolyte according to claim 10, further comprising at least one of LiN(SO₂F)₂ and LiPF₆.

12. The electrolyte according to claim 11, wherein a concentration of the LiN(SO₂F)₂ is 0.1 mol/L or more and 1.0 mol/L or less.

13. The electrolyte according to claim 11 or 12, wherein a concentration of the LiPF₆ is 0.5 mol/L or more and 1.5 mol/L or less.
